(19) United States
(12) Patent Application Publication
(10) Pub. No.: US 2009/0289221 A1
(43) Pub. Date: Nov. 26, 2009

(54) Use Of Aminoacetones And Salts Thereof As Bleaching Boosters For Peroxygen Compounds

(75) Inventors: Gerd Reinhardt, Kelkheim (DE); Georg Borchers, Bad Nauheim (DE); Michael Seebach, Hofheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Finance (BVI) Limited, Tortola (VG)

(21) Appl. No.: 12/376,423

(22) PCT Filed: Jul. 31, 2007
(86) PCT No.: PCT/EP07/06742

§ 371 Date: Feb. 4, 2009

(30) Foreign Application Priority Data
Aug. 4, 2006 (DE) 10 2006 036 889.4

(51) Int. Cl. C11D 3/395

(52) U.S. Cl. 252/186.43

(57) ABSTRACT

The use is claimed of aminoacetones or salts thereof of the general formulae (I) and (II) in which R¹ and R² are each independently hydrogen, C₁-C₂₂-alkyl, C₂-C₂₂-alkenyl, phenyl or C₅-C₈-cycloalkyl, or R¹ and R², together with the nitrogen atom, form a 5-, 6- or 7-membered ring system, X′ is anion, for example chloride, bromide, iodide, toluenesulfonate, benzenesulfonate, cumenesulfonate, mesitylsulfonate, sulfate, hydrogensulfate, acetate, fatty acid anion or anion of polycarboxylates, as a bleaching booster for inorganic peroxygen compounds in the pH range from 7 to 9.

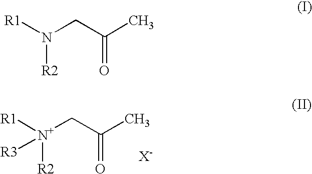

The present invention relates to the use of certain aminoacetones and salts thereof for increasing the bleaching effect of peroxygen compounds during the bleaching of colored soilings on textiles and also on hard surfaces, and to solid and liquid washing and cleaning compositions which comprise such aminoacetones and/or their salts.

To date, so-called chlorine bleaching, which is based on the bleaching effect of hypochlorite and/or other active-chlorine-containing compounds and is used both for bleaching textiles and also for hard surfaces, has been widespread. However, the high hypochlorite concentration required for an effective bleaching effect leads to severe color damage and may also result in fiber damage upon repeated use.

Inorganic peroxygen compounds have been used for a long time as oxidizing agents for disinfection and bleaching purposes. Typical examples which may be mentioned are hydrogen peroxide and solid peroxygen compounds, such as sodium perborate and sodium carbonate perhydrate, which dissolve in water to release hydrogen peroxide. The oxidizing effect of the peroxygen compounds is heavily temperature-dependent; adequately rapid bleaching is only achieved at temperatures above 80° C. The oxidizing effect of inorganic peroxygen compounds can be improved by adding so-called bleach activators, meaning that even at temperatures around 60° C. essentially the same bleaching result is achieved as with the peroxide solution on its own at 95° C. Examples of bleach activators which may be mentioned are compounds from the group of N- and O-acyl compounds, such as polyacylated alkylenediamines, in particular tetraacetylethylenediamine (TAED), tetraacetylglucouril (TAGU), N-acylated hydantoins, hydrazides, triazoles, hydrotriazines, urazoles, diketopiperazines, sulfurylamides and cyanurates, as well as carboxylic acid anhydrides, in particular phthalic anhydride and substituted maleic anhydrides, carboxylic acid esters, in particular sodium nonanoyloxybenzenesulfonate (NOBS), sodium isononanoyloxybenzenesulfonate (ISONOBS) and acylated sugar derivatives, such as pentaacetylglucose (PAG).

At washing temperatures below 60° C., in particular below 45° C. down to the temperature of cold water, the effect of the bleach activators known hitherto often deteriorates. A further considerable disadvantage of the specified bleach activators is their limited effectiveness in the pH range <9. Since a high perhydroxyl anion concentration is required for their activation, known activators are most effective preferably between pH 9 and 11. However, this gives rise to deficits in certain areas of application, such as, for example, in liquid detergents or neutral and low-alkaline detergent and cleaner formulations.

There has been no lack of attempts to develop more effective bleaches although convincing success has not been noted to date. Thus, the literature describes numerous metal-containing bleach catalysts which are used together with peroxides. The use of metal-containing bleach catalysts, however, often has the disadvantage that damage to the fabric and the dyes used can occur.

U.S. Pat. No. 3,822,114 describes metal-free bleaching compositions which, besides an organic or inorganic peroxygen compound, comprise cyclic and open-chain aldehydes and ketones as bleaching boosters. These systems permit a good oxidizing effect at temperatures above 25° C. Further bleaching boosters are protected, inter alia, in WO 95/31527 (bi- and tricyclic ketones, such as, for example, decalin-1,5-dione, methyldecalin-1,6-dione and tricycloundecanedione) and in EP 1 209 221 (sugar ketones). U.S. Pat. No. 5,785,887 protects the use of cyclic and open-chain monoketals of diketones, such as, for example, cyclohexanedione, as bleach activators. Neither in WO 95/31527, U.S. Pat. No. 3,822,114 nor in U.S. Pat. No. 5,785,887 are aminoacetones or salts thereof described as bleaching boosters.

It was an object of the invention to improve the oxidizing effect and bleaching effect of in particular inorganic peroxygen compounds in the temperature range from 10° C. to 45° C. and pHs in the range from 7 to 9.

Surprisingly, it has now been found that certain aminoacetones and salts thereof considerably improve the cleaning performance of inorganic peroxygen compounds on colored soilings located on textiles and on hard surfaces. Surprisingly, it has furthermore been found that the cleaning results of these aminoacetones and salts thereof are best at a pH in the range from 7 to 9.

The invention provides the use of aminoacetones or salts thereof of the formulae (I) and (II)

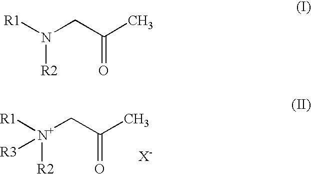

in which R¹ and R², independently of one another, are hydrogen, C₁-C₂₂-alkyl, C₂-C₂₂-alkenyl, phenyl or C₅-C₈-cycloalkyl, or R¹ and R², together with the nitrogen atom, form a 5, 6 or 7-membered ring system, X⁻ is an anion, preferably chloride, bromide, iodide, toluenesulfonate, benzenesulfonate, cumenesulfonate, mesitylsulfonate, sulfate, hydrogensulfate, acetate, a fatty acid anion or an anion of polycarboxylates. Suitable fatty acid anions are in particular anions of C₈-C₂₂-carboxylic acids. Anions of polycarboxylates are preferably anions of polyacrylic acid or of copolymers of maleic anhydride and acrylic acid.

Since the aminoacetones, in particular those with short-chain radicals R¹ and R², are liquid, readily volatile compounds, they are preferably used in the form of their salts; to improve handling, in a particular embodiment, these are adsorbed to a solid carrier material.

Syntheses of corresponding aminoacetones are described in R. Stoermer et al., Chem. Ber., 28, 1895, 2220-2227 and Chem. Ber., 29, 1896, 866-874, in J. Magge and H. Henze, J. Amer. Chem. Soc., 60, 1938, 2148-2151, in J. King and McMillan, J. Amer. Chem. Soc., 73, 1951, 4451-4453 and in H. Zaugg and B. Horrom, J. Amer. Chem. Soc., 72, 1950, 3004-3007. The synthesis generally takes place by reacting a dialkylamine with monohaloacetone in a solvent. The formation of the salts takes place by reacting the aminoacetone with an inorganic or organic acid. Preferred acids are hydrochloric acid, sulfuric acid, p-toluenesulfonic acid, acetic acid, lauric acid, benzoic acid or polymeric carboxylic acids, such as acidic or partially neutralized polyacrylic acids and copolymers of acrylic acid and maleic acid.

Particularly preferred aminoacetones and salts thereof are:

N,N-dimethylaminoacetone, N,N-diethylaminoacetone, N,N-dipropyl-aminoacetone, N,N-n-dibutylaminoacetone and N,N-diisobutyl-aminoacetone, piperidylacetone, 1-morpholin-4-yl-acetone, and N,N-dimethylaminoacetone hydrochloride, N,N-diethylaminoacetone hydrochloride, N,N-diethylaminoacetone hydrogensulfate, N,N-diethylaminoacetone acetate, N,N-diethylaminoacetone polycarboxylate, N,N-dipropylaminoacetone hydrochloride, N,N-di-n-butylaminoacetone hydrochloride, N,N-diisobutylaminoacetone hydrochloride, piperidylacetone hydrochloride, and 1-morpholin-4-yl-acetone hydrochloride.

The aminoacetones and salts thereof can either in each case be used as they are or in a mixture.

The aminoacetones and salts thereof can be used in detergents and cleaners both with and without use of a carrier. In pulverulent or tableted products, the use of the aminoacetones and/or salts thereof on carrier materials as compounds is preferred.

Suitable carrier materials are, for example, clays, silicates, carbonates, phosphates, sulfates and citrates. Clays are naturally occurring crystalline or amorphous silicates of aluminum, iron, magnesium, calcium, potassium and sodium, for example kaolin, talc, pyrophyllite, attapulgite, sepiolite, saponites, hectorites, smectites, such as montmorillionite, in particular bentonites, bauxite and zeolites. Crystalline layered alkali metal silicates of the formula MM′SiₓO₍₂ₓ₋₁₎*yH₂O (M,M′=Na, K, H, x=1.9-23; y=0-25), preferably sodium silicates, for example grades available under the trade names SKS-6 and Nablon® 15 are suitable. Zeolites of type A and P are likewise suitable.

Bentonites are particularly suitable, such as those commercially available under the name Copisil® S 401, Copisil® N 401, Laundrosil® DGA, Laundrosil® EX 0242, Copisil® S 401, Copisil® N 401 or Ikomont® CA white. Sheet silicates can also be used in acidically modified form, as are available in the commercial products Tonsil® EX 519, Tonsil Optimum 210 FF, Tonsil Standard 310 FF and 314 FF, and also Opazil® SO from Südchemie.

Further suitable carrier materials may be amorphous polysilicas whose internal surface area is preferably in the range from 10 m²/g to 500 m²/g, in particular 100 m²/g to 450 m²/g. Silicas which have been produced by the thermal process (flame hydrolysis of SiCl₄) (so-called fumed silicas), and also silicas prepared by wet methods (so-called precipitated silicas) are suitable. They can also be prepared by the action of mineral acids on waterglass.

Further particularly suitable carrier materials are sodium or potassium sulfates, sodium carbonates and sodium hydrogencarbonates, and also alkali metal phosphates, which may be present in the form of their alkaline, neutral or acidic sodium or potassium salts. Examples thereof are trisodium phosphate, tetrasodium diphosphate, disodium dihydrogendiphosphate, pentasodium triphosphate, so-called sodium hexametaphosphate, oligomeric trisodium phosphate with degrees of oligomerization of from 5 to 1000, in particular 5 to 50, and mixtures of sodium and potassium salts.

Organic carrier materials which can be used are, for example, the carboxylic acids used preferably in the form of their sodium salts, such as citric acid, nitriloacetate (NTA) and ethylenediaminetetraacetic acid. Analogously to this, it is also possible to use polymeric carboxylates and salts thereof. These include, for example, the salts of homopolymeric or copolymeric polyacrylates, polymethacrylates and in particular copolymers of acrylic acid with maleic acid, preferably those composed of 50% to 10% maleic acid, polyaspartic acid and also polyvinylpyrrolidone and urethanes. The relative molecular mass of the homopolymers is generally between 1000 and 100 000, that of the copolymers is between 2000 and 200 000, preferably 50 000 to 120 000, based on the free acid. In particular, water-soluble polyacrylates which are crosslinked, for example, with about 1% of a polyallyl ether of sucrose and which have a relative molecular mass above one million are also suitable. Examples thereof are the polymers available under the name Carbopol 940 and 941.

In a particular embodiment, in this connection, the salts of the aminoacetones according to the invention can be prepared in situ, e.g. by spraying the aminoacetone onto an acidic or only partially neutralized carrier (e.g. polyacrylic acid).

The compounds according to the invention consist of 20 to 98% by weight, preferably 30 to 95% by weight, particularly preferably 40 to 90% by weight, of carrier material, the remainder is the aminoacetone or salt thereof, optionally also further auxiliaries.

In a further preferred embodiment, these pulverulent compounds can be in granulated form. Suitable binders for the granulation may be cellulose and starch, as well as ethers or esters thereof, for example carboxymethylcellulose (CMC), methylcellulose (MC) or hydroxyethylcellulose (HEC) and the corresponding starch derivatives, but also film-forming polymers, for example polyacrylic acids and copolymers of maleic anhydride and acrylic acid, and also the salts of these polymeric acids. Standard commercial products are, for example, Sokalan® CP 5 or 45, Sokalan® CP 12 S or CP 3S.

Binders and granulation auxiliaries which may be used are also surfactants, in particular anionic and nonionic surfactants, surfactant compounds, di- and polysaccharides, cyclodextrins, meltable polyesters, polyalkylene glycols, in particular polyethylene glycols, polypropylene glycols, particularly preferably polyethylene glycols with molecular weights of from 1000 to 10 000, preferably 3000 to 6000, particularly preferably 4000, fatty acids, in particular saturated fatty acids, such as lauric acid, myristic acid, palmitic acid, stearic acid, hydrogenated erucic acid and behenic acid, and also mixtures derived in particular from natural fatty acids, e.g. coconut, palm kernel or tallow fatty acids, soaps, in particular saturated fatty acid soaps and waxes.

The amount of auxiliaries, likewise based on the finished bleaching compound, can be 0 to 45% by weight, preferably 2 to 20% by weight.

In a preferred embodiment, the pulverulent carrier material is initially introduced into a mixer, preferably plowshare mixer or intensive mixer, and charged with an aqueous aminoacetone solution or aminoacetone salt solution. In this connection, a specific charging limit arises depending on the concentration of the solution, the carrier substance used and the process parameters. Typically, charges of ca. 20-70% by weight of solution (based on fraction in the total compound) can be achieved. After the granulation, the moist product is dried, for which preferably moving-bed or fluidized-bed driers are used. After the drying, granules are obtained which typically have an active content of 10-60% aminoacetone or aminoacetone salt. The coarse particle fraction and the fines fraction are separated off from the granules produced by sieving. The coarse particle fraction is comminuted by grinding and, like the fines fraction, fed to a fresh granulation process. The particle size of the granules prepared in this way is generally in the range from 50 to 2000 μm, preferably 150 to 1800 μm, particularly preferably from 300 to 1500 μm.

In a further embodiment, after attaching the aqueous aminoacetone solution or aminoacetone salt solution to the carrier material, a shaping granulation of the mixture can be carried out by dies in the extruder, but also by annular edge-mill presses, edge-mill runners. Here, the carrier material should be selected and the charging concentration adjusted such that the mixture has adequate plastic deformability. The extrudates obtained from the process can optionally be rounded in a spheronizer. Finally, the granules are dried and processed in an analogous manner, as described above.

In another preferred embodiment, the aminoacetone solution or aminoacetone salt solution is sprayed onto the carrier material and granulated in a fluidized-bed granulation process. Since the process offers the advantage of simultaneous granulation and drying, compared to a sequential process involving application to a support in the mixer with subsequent drying, higher charges can generally be achieved. The charging limit is then determined by the physical properties of the individual components and/or of the mixture.

The granules obtained according to the invention are directly suitable for use in detergents and cleaners. In a particularly preferred use form, however, they can be provided with a coating shell by processes known per se. For this, the granules are coated in an additional step with a film-forming substance, as a result of which the product properties can be considerably influenced.

Suitable coating compositions are all film-forming substances, such as waxes, silicones, fatty acids, fatty alcohols, soaps, anionic surfactants, nonionic surfactants, cationic surfactants, anionic and cationic polymers, and also polyalkylene glycols. Preference is given to using coating substances with a melting point of 30-100° C. Examples thereof are: C₈-C₃₁-fatty acids, for example lauric acid, myristic acid, stearic acid; C₈-C₃₁-fatty alcohols; polyethylene glycols with a molar mass of from 1000 to 50 000 g/mol; fatty alcohol polyalkoxylates with 1 to 100 moles of EO; alkanesulfonates, alkylbenzenesulfonates, α-olefinsulfonates, alkylsulfates, alkyl ether sulfates with C₈-C₃₁-hydrocarbon radicals, polymers, for example polyvinyl alcohols, waxes, for example montan waxes, paraffin waxes, ester waxes, polyolefin waxes, silicones.

Moreover, in the coating substance which softens or melts in the range from 30 to 100° C. there may be present further substances which do not melt or soften in this range, in dissolved or suspended form, for example homopolymers, copolymers or graft copolymers of unsaturated carboxylic acids and/or sulfonic acids, and alkali metal salts thereof, cellulose ethers, starch, starch ethers, polyvinylpyrrolidone; mono- and polybasic carboxylic acids, hydroxycarboxylic acids or ether carboxylic acids having 3 to 8 carbon atoms, and also salts thereof; silicates, carbonates, bicarbonates, sulfates, phosphates, phosphonates. Depending on the desired properties of the coated granules, the content of coating substance can be 1 to 30% by weight, preferably 5 to 15% by weight, based on the coated granules.

To apply the coating substances, mixers (mechanically induced fluidized bed) and fluidized-bed apparatuses (pneumatically induced fluidized bed) can be used. Possible mixers are, for example, plowshare mixers (continuous and batchwise), annular bed mixers or else Schugi mixers. When a mixer is used, the heating can take place in a granule preheater and/or directly in the mixer and/or in a fluidized bed downstream of the mixer. To cool the coated granules, granule coolers or fluidized-bed coolers can be used. In the case of fluidized-bed apparatuses, the heating takes place via the heating gas used for fluidization. The granules coated by the fluidized-bed process can, in a similar manner to the mixing process, be cooled via a granule cooler or a fluidized-bed cooler. Both during the mixing process and also during the fluidized-bed process, the coating substance can be sprayed on via a single-substance or a twin-substance nozzle device. The optional heating consists in a thermal treatment at a temperature of from 30 to 100° C., but at or below the melting or softening temperature of the particular coating substance. Preference is given to working at a temperature which is just below the melting or softening temperature.

The bleach compounds according to the invention are characterized by very good storage stability in pulverulent detergent, cleaner and disinfectant formulations. They are ideal for use in standard detergents, stain removal salts, machine dishwashing compositions and pulverulent all-purpose cleaners.

The aminoacetones or salts thereof are used in the detergents and cleaners according to the invention, which moreover also comprise organic or inorganic peroxygen compounds, in concentrations of from 0.01 to 10%, preferably 0.1 to 8% and in particular 0.5 to 5%.

Suitable peroxygen compounds are primarily all alkali metal or ammonium peroxosulfates, such as, for example, potassium peroxomonosulfate (industrially: Caroat® or Oxone®). For use in alkaline pulverulent formulations, it is advantageous to use potassium peroxomonosulfate (mostly in the form of the triple salt) in the form of granules, as are described, for example, in DE 196 46 225, in order to increase their storage stability. In addition, however, it is also possible to use alkali metal perborate monohydrate or tetrahydrate and/or alkali metal percarbonate, where sodium is the preferred alkali metal. The concentration of the inorganic oxidizing agents in the total formulation of the cleaners is 1 to 90%, but preferably 5 to 25%.

Additionally or alternatively, the cleaners according to the invention can comprise organic-based oxidizing agents in the concentration range from 1 to 20%. These include all known peroxycarboxylic acids, such as, for example, monoperoxyphthalic acid, dodecanediperoxy acid or phthalimidoperoxycarboxylic acids such as PAP.

The term “bleaching” is understood here as meaning both the bleaching of dirt located on the textile surface, and also the bleaching of dirt detached from the textile surface and located in the wash liquor. The same applies analogously for the bleaching of soilings located on hard surfaces. Further potential uses can be found in the personal care sector, e.g. for improving the effectiveness of denture cleaners. Furthermore, the complexes according to the invention are used in commercial laundries, in the bleaching of wood and paper, the bleaching of cotton and in disinfectants.

Furthermore, the invention relates to a detergent or cleaner, such as, for example, washing and bleaching compositions for textile materials, cleaners for hard surfaces, such as dishwashing detergents or denture cleaners, which comprise the aminoacetones or salts thereof as defined above and peroxygen compounds.

The use of the aminoacetones and salts thereof as bleaching catalysts consists essentially in, in the presence of a hard surface contaminated with colored soilings, or of an appropriately soiled textile, providing conditions under which a peroxidic oxidizing agent and the aminoacetone or an aminoacetone salt can react with the aim of obtaining more strongly oxidizing resultant products, e.g. with dioxirane structure. Such conditions are present particularly when the reactants meet in aqueous solution. This can happen through the separate addition of the peroxygen compound and of the aminoacetone or salt thereof to a solution containing detergent or cleaner. The cleaner or detergent particularly advantageously comprises the aminoacetone or an aminoacetone salt and optionally a peroxygen-containing oxidizing agent from the beginning. The peroxygen compound can also be added to the solution separately without a diluent or in the form of a preferably aqueous solution or suspension when a peroxygen-free detergent or cleaner is used.

The detergents and cleaners according to the invention, which may be in the form of granules, pulverulent or tablet-like solids, other moldings, homogeneous solutions or suspensions, can in principle comprise all ingredients that are known and customary in such compositions apart from the specified aminoacetones and salts thereof.

The detergents and cleaners according to the invention can in particular comprise builder substances, surface-active surfactants, sequestrants, enzymes, and special additives with a color-care or fiber-care effect. Further auxiliaries such as electrolytes, foam regulators and also dyes and fragrances are possible.

To establish a desired pH which does not arise by itself as a result of mixing the other components, the compositions according to the invention can comprise system- and environment-compatible acids, in particular citric acid, acetic acid, tartaric acid, malic acid, lactic acid, glycolic acid, succinic acid, glutaric acid and/or adipic acid, but also mineral acids, in particular sulfuric acid or alkali metal hydrogensulfates, or bases, in particular ammonium or alkali metal hydroxides. pH regulators of this type are preferably not present in the compositions according to the invention above 10% by weight, in particular from 0.5 to 6% by weight.

### EXAMPLES

### Comparative Example

### Synthesis of N,N,N-diethylmethylammonium acetone tosylate

19.4 g (0.15 mol) of N,N-diethylaminoacetone were dissolved in 70 ml of acetonitrile and the solution was admixed over the course of 10 min at 35° C. with 27.9 g (0.15 mol) of methyl p-toluenesulfonate and left to after-react for 24 h. The clear solution was evaporated down completely and the crude product was recrystallized from isopropanol/methyl acetate.

Yield: 41.3 g of white solid

### Example 1

### Synthesis of N,N-diethylaminoacetone

478 g (6.54 mol) of diethylamine were dissolved in 650 ml of diethyl ether. At 35° C., 302.4 g (3.27 mol) of chloroacetone were added dropwise with stirring over the course of 10 min. An initially slight cloudiness increased in the course of the addition of chloroacetone. After 6 h at 45° C., the resulting yellow-brown suspension was cooled and filtered with suction at a temperature of 0° C. The precipitated diethylaminohydrochloride was washed with diethyl ether, the filtrate was then evaporated down in vacuo and cooled at 0° C. for 12 h. Freshly crystallized diethylaminohydrochloride was filtered off with suction and washed with a small amount of cold diethyl ether. The ethereal solution of the diethylaminoacetone was evaporated down completely in vacuo and the brown oil which remained was subjected to fractional distillation in vacuo. Boiling point 67 to 70° C. (49 mbar).

Yield of diethylaminoacetone: 337 g (2.6 mol), 79.8%

The diethylaminohydrochloride which forms as by-product can be converted again to the free amine by adding a base, and be used for further experiments.

### Example 2

### Synthesis of N,N-diethylaminoacetone hydrochloride

100 g (0.77 mol) of N,N-diethylaminoacetone were dissolved in 387 ml of water and the solution was admixed with 1N hydrochloric acid (774 ml, 0.77 mol) with stirring over the course of 10 min. The reaction mixture was then evaporated down completely in vacuo at 60° C., the product being isolated in a yield of 99.5%.

### Example 3

### Neutralization of N,N-diethylaminoacetone with Sokalan® CP 45

5.0 g of N,N-diethylaminoacetone were dissolved in water such that a 50% strength aqueous solution was present. The pH of the solution was 10.1. Then, with stirring and gentle heating to 38° C., 43.5 g of a 14.3% strength aqueous Sokalan solution was added, the pH being 7 when addition was complete. The 14.3% strength Sokalan solution was prepared by dissolving 20.0 g of Sokalan® CP 45 in 120 ml of water. The reaction mixture was evaporated down completely in vacuo at 60° C., with 9.8 g of the crystalline product with an active content of 44.6% being isolated.

### Example 4

### Neutralization of N,N-diethylaminoacetone with p-toluenesulfonic acid

1.29 g of N,N-diethylaminoacetone were dissolved in 5 ml of water. The pH of the solution was 10.1. Then, with stirring and gentle heating to 28° C., 1.9 g of p-toluenesulfonic acid monohydrate were added, the pH being 7 when addition was complete. The reaction mixture was evaporated down completely in vacuo at 60° C., giving 3.3 g of an orange colored resin which then crystallized in the refrigerator. 2.8 g of yellow-orange crystals were obtained.

### Example 5

### Synthesis of N,N-dipropylaminoacetone

202.38 g (2 mol) of dipropylamine were dissolved in 200 ml of diethyl ether. At 35° C., 92.53 g (1 mol) of chloroacetone were added dropwise with stirring over the course of 10 min. An initially slight cloudiness increased in the course of the addition of chloroacetone. After 6 h at 45° C., the resulting whitish-yellow suspension was cooled and filtered with suction at a temperature of 0° C. The precipitated dipropylaminohydrochloride was washed with diethyl ether, the filtrate was then evaporated down in vacuo and cooled at 0° C. for 12 h. Freshly crystallized dipropylaminohydrochloride was filtered with suction and washed with a small amount of cold diethyl ether. The ethereal solution of the dipropylaminoacetone was evaporated down completely in vacuo and the remaining brown oil was subjected to fractional distillation in vacuo. Boiling point 62° C. (5 mbar). Yield: 123.1 g.

### Example 6

### Synthesis of N,N-dipropylaminoacetone hydrochloride

5 g (31.8 mmol) of N,N-dipropylaminoacetone were dissolved in 15.9 ml of water and the solution was admixed with 1N hydrochloric acid (31.8 ml, 31.8 mmol) with stirring over the course of 10 min. The reaction mixture was then evaporated down completely in vacuo at 60° C., the hygroscopic product being isolated in a yield of 98%.

### Example 7

### Synthesis of N,N-diisobutylaminoacetone

258.5 g (2 mol) of diisobutylamine were dissolved in 200 ml of diethyl ether. At 35° C., 92.53 g (1 mol) of chloroacetone were added dropwise with stirring over the course of 10 min. An initially slight cloudiness increased in the course of the addition of chloroacetone. After 6 h at 45° C., the resulting whitish-yellow suspension was cooled and filtered with suction at a temperature of 0° C. The precipitated diisobutylaminohydrochloride was washed with diethyl ether, the filtrate was then evaporated down in vacuo and cooled at 0° C. for 12 h. Freshly crystallized diisobutylaminohydrochloride was filtered off with suction and washed with a small amount of cold diethyl ether. The ethereal solution of the diisobutylaminoacetone was evaporated down completely in vacuo and the remaining brown oil was subjected to fractional distillation in vacuo. Boiling point 74° C. (5 mbar). Yield: 86.9 g of colorless oil.

### Example 8

### Synthesis of N,N-diisobutylaminoacetone hydrochloride

5 g (27 mmol) of N,N-diisobutylaminoacetone were dissolved in 13.5 ml of water and the solution was admixed with 1N hydrochloric acid (27 ml, 27 mmol) with stirring over the course of 10 min. The reaction mixture was then evaporated down completely in vacuo at 60° C., the product being isolated in a yield of 85%.

### Example 9

### Synthesis of N,N-di-n-butylaminoacetone hydrochloride

5 g (27 mmol) of N,N-di-n-butylaminoacetone (prepared according to Example 7 from di-n-butylamine and chloroacetone) were dissolved in 13.5 ml of water and the solution was admixed with 1N hydrochloric acid (27 ml, 27 mmol) with stirring over the course of 10 min. The reaction mixture was then evaporated down completely in vacuo at 60° C., the product being isolated in a yield of 95%.

### Example 10

### Synthesis of Piperidylacetone

170.3 g (2 mol) of piperidine were dissolved in 200 ml of diethyl ether. At 35° C., 92.53 g (1 mol) of chloroacetone were added dropwise with stirring over the course of 10 min. An initially slight cloudiness increased in the course of the addition of chloroacetone. After 6 h at 45° C., the resulting whitish-yellow suspension was cooled and filtered with suction at a temperature of 0° C. The precipitated piperidine hydrochloride was washed with diethyl ether, the filtrate was then evaporated down in vacuo and cooled at 0° C. for 12 h. Freshly crystallized piperidine hydrochloride was filtered off with suction and washed with a small amount of cold diethyl ether. The ethereal solution of the piperidylaminoacetone was evaporated down completely in vacuo and the remaining brown oil was subjected to fractional distillation in vacuo. Boiling point 60° C. (5 mbar). Yield: 118.4 g of colorless oil.

### Example 11

### Synthesis of Piperidylacetone Hydrochloride

5 g (36.7 mmol) of piperidylaminoacetone were dissolved in 18.4 ml of water and the solution was admixed with 1N hydrochloric acid (36.7 ml, 36.7 mmol) with stirring over the course of 10 min. The reaction mixture was then evaporated down completely in vacuo at 60° C., the hygroscopic product being isolated in a yield of 100%.

### Example 12

### pH Dependence of the Bleaching (Comparison of Diethylaminoacetone, Diethylaminoacetone Hydrochloride and Diethylmethylammonium Acetone Tosylate)

To ascertain the pH dependence of the bleaching of the diethylaminoacetone and diethylaminoacetone hydrochloride according to Example 1 and Example 2 respectively, washing experiments were carried out in a beaker at 25° C. using a mechanical stirrer. For this, 2 g/l of standard detergent IEC A (wfk Krefeld) were dissolved in 400 ml of water of hardness 15° German hardness, 0.35 g/l of caroate and 0.04 g/l of the sample were added. After adjusting the pH with acid or base, in each case 4 cloths of test fabric BC-1 (tea on cotton, wfk Krefeld) were added and the wash liquor was stirred for 60 min, during which the pH was kept constant. Before and after the washing, the whiteness of the test soiling was determined using an Elrepho measuring instrument. As result, the whiteness (dE) was given as a function of the pH:

| Sample | pH 5 | pH 7 | pH 8 | pH 9 | pH 10 | pH 11 |
|---|---|---|---|---|---|---|
| Example 1 | 53.5 | 52.5 | 57.2 | 48.3 | 48.7 | 46.5 |
| Example 2 | 53.6 | 51.9 | 59.7 | 50.8 | 50.0 | 45.4 |
| Caroate | 48.3 | 8.5 | 47.6 | 48.0 | 48.2 | 47.8 |
| Comparative example | 47.3 | 47.2 | 48.0 | 48.5 | 48.6 | 48.0 |

The results illustrate a bleaching optimum of the ketones according to the invention at pH 8 whereas the comparison compound, the quaternized aminoacetone, has no bleaching effect in this pH range. The bleaching is likewise not pH dependent without ketone additives (only caroate).

### Example 13

### Bleaching Performance of Dialkylaminoacetones and Salts Thereof

5 g/l of standard liquid detergent (pH 7.3) are dissolved in 200 ml of water (15° German hardness). 0.35 g/l of caroate and 0.04 g/l of a dialkylaminoacetone or dialkylaminoacetone salt are added. 4 cloths of test fabric BC-3 (tea on cotton, wfk-Krefeld) are added and the washing experiment is carried out in a Linitest instrument from Heraus (Hanau) for 30 min at 40° C. After the washing process, the cloths are rinsed with water and dried. The reflectance is determined using an Elrepho whiteness measuring instrument. As result, the difference in reflectance between the sample washed with the aforementioned bleaching system compared to the test fabric which has only been washed with liquid detergent is given.

| Dialkylaminoacetone | Difference in reflectance |
|---|---|
| Example 1 | 2.7 |
| Example 5 | 4.1 |
| Example 6 | 3.8 |
| Example 7 | 4.0 |
| Example 9 | 2.4 |
| Example 10 | 2.8 |
| Example 11 | 2.6 |
| Only caroate | 1.0 |

The results show that all of the tested dialkylaminoacetones act as performance boosters for caroate. If a standard powder detergent (pH 10.3) is used instead of the neutral liquid detergent, no bleach-boosting effects are observed with the dialkylaminoacetones according to the invention. This demonstrates the effectiveness of the ketones according to the invention in the claimed pH range <9.

### Example 14

### Mixer Granulation of Diethylaminoacetone Hydrochloride

In a laboratory mixer, 61.7 g of the acid-modified bentonite Copisil S 401, with a dry content of ca. 81%, are initially introduced and charged with 41.6 g of a 50% strength aqueous solution of the diethylaminoacetone hydrochloride. The resulting moist product is then transferred to a laboratory fluidized-bed drier (model Retsch TG 100). The material is dried for 20 min at T=50° C. and the granule fraction 315-1250 μm was then sieved out. The granules obtained in this way have an active ingredient content of ca. 29.4% diethylaminoacetone hydrochloride.

1. A process for boosting the effectiveness of inorganic peroxygen compounds comprising the step of adding at least one salt of at least one aminoacetone of the formula (I) 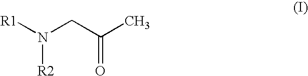
wherein R¹ and R²,independently of one another, are hydrogen, C₁-C₂₂-alkyl, C₂-C₂₂-alkenyl, phenyl or C₅-C₈-cycloalkyl, or R¹ and R², together with the nitrogen atom, form a 5, 6 or 7-membered ring system, to an aqueous bath in the pH range 7 to 9.

2. A process according to claim 1, wherein the at least one salt of at least one aminoacetone is
N,N-diethylaminoacetone hydrochloride 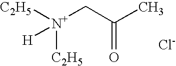
.

3. A bleaching system consisting essentially of at least one salt of at least one aminoacetone of the formula (I) 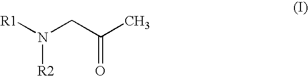
wherein R¹ and R², independently of one another, are hydrogen, C₁-C₂₂-alkyl, C₂-C₂₂-alkenyl, phenyl or C₅-C₈-cycloalkyl, or R¹ and R², together with the nitrogen atom, form a 5, 6 or 7-membered ring system and an inorganic peroxygen compound.

4. The bleaching system as claimed in claim 3, wherein the peroxygen compound, is an alkali metal or ammonium peroxomonosulfate or mixtures thereof with alkali metal perborate mono- or tetrahydrate and/or alkali metal percarbonates.

5. A bleaching compound consisting essentially of a carrier material onto which at least one salt of at least one aminoacetone of the formula (I) 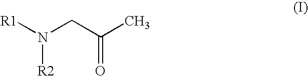
wherein R¹ and R², independently of one another, are hydrogen, C₁-C₂₂-alkyl, C₂-C₂₂-alkenyl, phenyl or C₅-C₈-cycloalkyl, or R¹ and R², together with the nitrogen atom, form a 5, 6 or 7-membered ring system is applied.

6. The bleaching compound as claimed in claim 5, which comprises 40 to 90% by weight of carrier material and 10 to 60% by weight of the at least one salt of at least one aminoacetone.

7. The bleaching compound as claimed in claim 5, which further comprises additional binders and/or granulation auxiliaries.

8. A process for the preparation of the bleaching compound as claimed in claim 5, which comprises mixing the at least one salt of at least one aminoacetone of the formula (I), the carrier material and any additional components and optionally granulating and drying this mixture.

9. A washing, bleaching or cleaning composition comprising at least one salt of at least one aminoacetone of the formula (I) 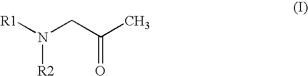
wherein R¹ and R², independently of one another, are hydrogen, C₁-C₂₂-alkyl, C₂-C₂₂-alkenyl, phenyl or C₅-C₈-cycloalkyl, or R¹ and R², together with the nitrogen atom, form a 5, 6 or 7-membered ring system.

10. A washing, bleaching or cleaning composition comprising a bleaching compound as claimed in claim 5.
